(19) United States
(12) Patent Application Publication
(10) Pub. No.: US 2026/0243970 A1
(43) Pub. Date: Aug. 20, 2026

(54) Optical fibre connection fault detector

(71) Applicant: DexGreen Limited, Cork (IE)

(72) Inventors: Chris Horgan, Cork (IE); Mark Horgan, Cork (IE); Brian McCarthy, Cork (IE); Billy Horgan, Cork (IE)

(21) Appl. No.: 19/153,690

(22) PCT Filed: Feb. 9, 2024
(86) PCT No.: PCT/EP2024/053308

§ 371 Date: Aug. 5, 2025

(30) Foreign Application Priority Data
Feb. 15, 2023 (GB) 2302151.2
Aug. 25, 2023 (GB) 2313039.6

(51) Int. Cl. G02B 6/38; G01M 11/00; G01M 11/02

(52) U.S. Cl. CPC G02B 6/385; G01M 11/0214; G01M 11/3154

(57) ABSTRACT

A fault detector tool includes a head designed to capture and isolate infra-red light leaking from an optical fibre connection such as a fusion splice or similar joint, and direct it to one or more photodiodes which are sensitive to optical communication transmission wavelengths. The output voltage of the photodetector is typically proportional to the levels of light leaking from the connection and so the detector provides a method of measuring optical power loss at a connection without requiring access to a termination point of the optical network. The device has the means to self-calibrate and indicate to the user if parts must be cleaned or repaired. The sensor ideally captures a broad spectrum of infra-red light covering all major telecommunication wavelengths. Optical power measurements are compared to threshold limits which estimate current and future performance of the splice. The device also measures and records other factors which contribute to poor connections, such as humidity and temperature. This information is fed into electronic processing devices which in turn can send data via Bluetooth or another wireless link to a smart device for real time updates and further analysis. The device is operated by a button which turns on the device. Calibration, measurement, logging and analysis of data is performed via a bespoke mobile app, communicating to the device via Bluetooth (or the like).

### FIELD OF THE INVENTION

The present invention relates to a fault detector for use in assessing joints in optical fibres.

### BACKGROUND ART

A small number of test devices for optical communications networks are known, mainly in the form of devices for identifying live fibres. In one form, these are designed to check at a termination end of the optical fibre whether an infrared (IR) light signal is present; one example of this is Fluke Networks' FibreLert system. In another form, these are designed to check for the presence of IR signals at a point along an optical cable, usually achieved by introducing a bend into the cable which induces leakage of light which can then be detected. An example of this type of device is shown in U.S. Pat. No. 8,976,344.

At present, the standard method of evaluating the performance of a newly-installed optical-fibre connection (such as a new splice between lengths of optical fibre) is through use of a Visual Fault Locator (VFL). This is a red laser pen that installers can connect to the fibre at the final customer connection point to send a test signal along the fibre. The installer must then return to the splice and check for red light leaking out from the splice. This is a time-consuming process that requires the installer to enter and leave the customer premises multiple times. More importantly, this is a subjective test. The observed brightness of the splice will depend on weather conditions, splice orientation in the cradle (for example, if a break is present on the side of the splice facing the inside wall of its enclosure, then it will appear less bright) and relies on the judgement of the installer to evaluate how much red light is “too much”.

U.S. Pat. No. 4,360,268, dates from 1980 and is therefore very early in the history of fusion splicing of optical fibres, which was first disclosed by Fujikura in 1979. It discloses an apparatus for field measurement of optical losses at a splice, which employs an integrating sphere placed around the splice and used to detect light leaking from the splice. The described context is a need to splice the free end of a very short pigtail or input fibre, that is connected to a light source such as a laser diode, to the free end of a very long fibre (e.g. 10 kilometers) of the same size and type that is connected to optical receiver equipment at a remote location. The short pigtail (with light source attached) is connected to an input port of the integrating sphere and a reference measurement of the light level within the sphere is taken from a radiometer which is linked to an output port via a short fibre bundle. Light within the sphere is diffused by the internal coating which, for an integrating sphere, has a uniform scattering or diffusing effect. An internal baffle prevents a direct line of sight from the input port to the output port and thus only the diffuse light is measured, in accordance with the usual principles of an integrating sphere. The splice is then made, and the spliced joint is placed within the integrating sphere and a second measurement is made of the light leaking form the splice. Comparison of the reference measurement and the second measurement yield a value for the proportion of light leaking from the splice joint. Further details of an integrating sphere can be found at https://en.wikipedia.org/w/index.php? title=Integrating_sphere&oldid=1136822935.

JP 2020-143921 suggests assessing an optical connection by measuring the inter-wavelength loss, specifically the difference in loss of test light at the connection at two different wavelengths.

CN 204374491U discloses an optical cable splice closure with a transparent casing to allow direct observation of the splice for assessment as above.

### SUMMARY OF THE INVENTION

The present invention seeks to provide a device for testing the quality of an optical fibre connection. Such connections are needed when fibres need to be joined, split, or terminated, for example within an interconnection terminal such as that disclosed in WO2022/043034. Such terminals are provided at an end-user location, for example, and accept an incoming fibre from the wider network which is spliced to one or more tailed connectors within the terminal. The connectors can then be presented at a port of the terminal, allowing devices to be linked to the fibre. Within the terminal, a splice tray is commonly provided, accommodating excess fibre length and the splice connection. The fibre also needs to be terminated with a suitable connector to allow it to be connected to a device; such connectors are often factory-fitted (such as in the tailed connectors mentioned above) but may also be in the form of so-called “field installable connectors” which can be fitted to a free end of an optical fibre in the field. The connection between the fibre and such a connector can also be tested via the present invention.

The quality of a splice or other connection affects the signal strength provided to the end user, the reliability of the optical communications channel, and the longevity of the connection. An accurate means of determining the quality of the connection would allow inadequate connections to be identified quickly and rectified ab initio when the installing engineer is on site, avoiding the expense of subsequent fault-identification processes and multiple rectification visits, and the associated end-user dissatisfaction.

The present invention therefore provides a test apparatus for an optical fibre connection, comprising a first body part and a second body part, capable of being brought together around a fibre having a connection, thereby to substantially enclose the connection, a least the first body part containing specularly reflective surfaces disposed adjacent the splice connection when the fibre is so enclosed; and an IR-sensitive photodetector disposed to detect light reflected from the specularly reflective surfaces.

This allows in-situ testing of an optical connection, sensing leakage of the (usually) IR-wavelength signal within the fibre, and thus not requiring access to any other locations on the network. It thus permits a speedy and reliable test of a splice or other form of connection, from only the splice location.

The specularly reflective surfaces of the present invention differ in principle from the diffusing reflective surfaces of the integrating sphere disclosed in U.S. Pat. No. 4,360,268. The principle of an integrating sphere is that the light measured by the detector has been incident on an internal surface and scattered from that surface prior to detection, ideally being scattered several times. In this way, an accurate reading is obtained. Direct transmission from the input to the output is highly undesirable and in U.S. Pat. No. 4,360,268 is prevented entirely by a baffle or by suitable location & orientation of the input and output ports. This however means that the device of U.S. Pat. No. 4,360,268 is only suitable for its disclosed context, i.e. splicing the free end of a very short pigtail or input fibre, that is connected to a light source such as a laser diode, to the free end of a very long fibre. In this context, the light signal that has been transmitted along the short pigtail fibre will be very strong. Connections at the other end of the long fibre cannot be tested using this apparatus since the attenuation of the light signal along the long fibre, which may include splitters or other causes of step attenuation, will cause the incident light level to be too low to accurately compare the reference measurement and the second measurement as both will be low and hence more affected by both random and systematic errors. Modern splices are also covered with splice protectors, a polyolefin tube with a hot melt adhesive glue, often heatshrinkable around the fibre and often including rigid supporting elements; these will further attenuate the leaking light and render the device of U.S. Pat. No. 4,360,268 ineffective.

According to the present invention, specularly reflective surfaces are employed within the cavity. Specular reflection, or regular reflection, is the mirror-like reflection of waves, such as light, from a surface in accordance with the law of reflection stating that a reflected ray of light emerges from the reflecting surface at the same angle to the surface normal as the incident ray, but on the opposing side of the surface normal in the plane formed by the incident and reflected rays (i.e. “i=r”). This therefore encourages a direct light path between the (assumed) leak in the splice and the photodetector, or a path with a minimal number of specular reflections. Indeed, within the present invention a baffle (such as disclosed in U.S. Pat. No. 4,360,268) is unnecessary and is ideally omitted. As a result, the light is more efficiently gathered within the cavity, especially at the infra-red wavelengths used in modern telecommunications, and measurement accuracy is less dependent on the incident light intensity. As a result, the device can be used in other contexts such as testing a connection at the consumer “end” of the fibre, remote from the light source.

We prefer that the body parts are opaque, thus eliminating outside sources of light and improving the reliability of the detection system. To assist further in this respect, a resilient seal can be provided on at least one of the body parts, located to form seal with the other body part when brought together.

The first and second body parts can be hingedly attached, making the device an easy-to-use system which needs only be opened to allow the fibre to be inserted, and closed around the fibre to allow the test to begin.

We prefer that one or more specularly reflective surfaces are also provided on the second body part, to improve accuracy and reliability of detection. In any case, the specularly reflective surfaces ideally collectively define an internal space whose surfaces are entirely specularly reflective, save for an aperture allowing light to reach the photodetector, an aperture through which the optical fibre enters, and (optionally) an aperture through which the optical fibre exits.

The photodetector is preferably disposed in the second body part.

An amplifier circuit can be provided, fed with an output derived from the photodetector. The photodetector can be one of a photodiode, photoresistor, phototransistor, or a photovoltaic light sensor, or a combination of these. The device can further include sensors adapted to detect one or more of temperature, humidity, atmospheric pressure, and moisture levels. These can be recorded along with the test results, and used to investigate influence of environmental conditions on the long-term reliability of a join.

The device can preferably detect the presence of an optical fibre splice, such as by means of varying levels of light transmission through the material of an optical fibre and the elements which protect it, such as a splice protector which often comprises plastics and/or a stabilizing metal band or similar.

We also prefer that the photodetector can detect and differentiate both visible light and infra-red light. This can be done, if need be, via the photodetector element comprising more than one photosensitive element, thereby to detect and differentiate multiple wavelengths of light.

The connection can be a splice connection between two lengths of optical fibre, or between an optical fibre and an optical fibre connector such as a field-installable connector. For testing splice connections, the test apparatus can be incorporated as part of the splicing apparatus. The apparatus preferably comprises a wireless transmitter for sending a signal derived from the output of the photodetector. We propose that the apparatus be used in combination with a mobile computing device having a wireless receiver for receiving a signal transmitted by the wireless transmitter, and a display for showing a test result based on an output derived from the photodetector. The mobile computing device can be a smartphone handset, for example. It ideally includes a network data connection, and carries an application program adapted to receive the test result and transmit it to a storage location connected to the network. The test apparatus is preferably further adapted to transmit at least one of the temperature, humidity, atmospheric pressure and/or moisture level data to the mobile computing device for storage along with the test result.

Thus, the invention provides a device which can measure the performance of reflective coatings by emitting light from an LED or similar compact light source which is reflected from a highly reflective surface and collected by a photosensitive element in the device.

The provision of a means for transmitting the data captured by the test device to a portable computing device (such as a smartphone handset) allows that data to be captured and made use of. Prior testing regimes such as the VFL would merely record a yes/no confirmation of whether the installer claimed that the test had been completed successfully. However, detailed data recorded in a consistent manner by the apparatus of the present invention could be retained for future reference and analysis. For example, the test result could be retrieved for review if the customer complained of service issues. The test results could be correlated against subsequent line performance data to identify correlations and, perhaps, review and refine the pass/fail thresholds for future installations. Test results could be compared for a range of reasons. One reason might be to identify installers who might benefit from additional training, or installers who might be good trainers for others.

Tracking failures will also aid in identifying where tools used in making the connection may need to be replaced, cleaned or calibrated.

The test apparatus can be provided as a standalone device, or can be integrated into another (preferably related) device. For example, the test apparatus could be integrated with a splice machine adapted to create a splice between two optical fibre ends. This would allow a splice to be created and tested in a single process step. Parts of the test apparatus such as the first body part and second body part could have a dual purpose, serving to both enclose the newly-created splice during testing and to shield it from the external environment during creation of the splice.

The invention also relates to a method of testing a connection. In the case of testing a splice connection, this can be quite straightforward and comprises the steps of providing a test apparatus as defined above, inserting the spliced fibre into the apparatus, and using the apparatus to take a measurement of the amount of light escaping from the splice.

In relation to testing a field-installable connector, the method comprises the steps of providing a test apparatus as defined above, inserting an unterminated fibre into the test apparatus and measuring a reference signal strength, terminating the fibre with a field-installable connector, inserting the terminated fibre into the test apparatus and measuring a signal strength. The first insertion thus yields a reference value, showing the signal strength reaching the fibre end.

The terminated fibre is preferably inserted once with a cap over the field-installable connector for a measurement of signal strength to be taken, and once without any covering over the field-installable connector, for another measurement of signal strength to be taken. This allows the leakage to be measured (from the step of inserting with a cap) but also allows a verification measurement of the light leaving the field-installable connector which should be the same as or close to the reference signal strength. If there is a significant difference between these values that there may be an issue with the fitting of the field-installable connector. In this method, the cap can be a dust cap, which are commonly provided with field-installable connectors for environmental protection of the connector when loose.

### BRIEF DESCRIPTION OF THE DRAWINGS

An embodiment of the present invention will now be described by way of example, with reference to the accompanying figures in which;

FIG. 1 shows a schematic illustration of an optical fibre network;

FIG. 2 shows a general view of a device embodying the invention with itslid open ready to accept a fibre joint such as a splice or other connection;

FIG. 3 shows a view of the device with the lid closed, ready for measurement;

FIG. 4 shows an exploded view of the internals of the device, including circuit boards and associated housings;

FIG. 5 shows the mating surfaces that hold an optical splice in place and exclude incoming ambient light;

FIG. 6 shows a suitable amplifier circuit for use in embodiments of the present invention; and

FIG. 7 shows the relationship between losses in the splice under test and the output of the device as described, for a range of incoming signal strengths.

### DETAILED DESCRIPTION OF THE EMBODIMENTS

At present there is no tool available for installers to measure performance of optical fibre connections at the splice or connection point. Current equipment used for this purpose requires reflectors to be placed in the circuit to check for light transmission, or an OTDR device to analyse reflected light along the optical network to check for high loss areas and breaks. Both of these require access to the start or end point of the optical network and involve very expensive measurement equipment.

A common tool used by installers is a red laser which is launched into the optical fibre at the customer termination point. The installer then checks if red light is visible leaving the splice. This method is by its nature inexact and relies on the installer's judgement on how much visible red light leaving is acceptable.

Poor splice quality is a major contributor to early-life failures while building a fibre network. Currently, poor splice quality is highlighted when the customer complains of poor quality or broken service. We have concluded that if the quality of a fusion splice could be measured simply & quickly by a technician in field conditions at the point of installation, this would improve installation compliance as it could identify a poor splice condition and enable the technician to remedy it on the spot, and avoid a costly revisit for repair. It is to be expected that similar problems will arise from faults in fitting field-installable connectors to optical fibres.

We describe herein a device developed to achieve this aim. It is capable of reliable detection of fully broken splices or other connections (i.e. where the customer receives no signal) at all expected network conditions. In addition, connections that are outside specified acceptable loss levels, but where the customer nevertheless has some signal, can be detected to varying degrees depending on customer's signal strength. At the average expected signal strength within a good network, all connections outside the allowable limits can be detected.

The device is intended to be operated via an App resident on a device carried by the technician, ideally a hand-held device such as a smartphone. In preferred embodiments, the app communicates with the device via a wireless protocol such as Bluetooth®, through which the device can be calibrated, sensitivity levels adjusted, and results obtained, displayed, and stored or recorded for future reference.

The optical signal strength delivered to the customer premises is dependent the amount of loss along the length of the network, and the quality of the splice in the termination unit provided at (or near) the customer. Incoming signal strength is usually measured in dBm, a measurement that describes signal power relative to a notional 1 mW signal. Thus, a 1 mW laser has a power of 0 dBm. Signal loss is measured in decibels (dB); this describes the difference in optical power across a defined section of networks, such as a connection, a length of fibre, a splitter etc. A 3 dB loss means the optical power is halved. As an example of this, if there is a total of 27 dB of loss within the network after a 0 dB source, the resulting power is −27dBm. To put this in context, this signal received after transmission is 1/512 the strength of the original, or 1.95 μW.

In this application, we use the term “Incoming Signal” to mean the amount of optical power at the customer's connection and the term “Splice Loss” to mean the optical power lost across the fusion splice or other form of connection in question. Carriers expect a certain amount of unavoidable loss in their networks, where the signal received by the customer may average −15 dBm±5 dBm, with a minimum acceptable signal often well below −20 dBm. Modern fusion splicing equipment is reported to be capable of preparing splices with losses of less than about 0.05 dB in the majority of cases. For many splices made in field conditions, the splice loss can be significantly higher due to factors such as operator error, poor fibre hygiene practices and poorly maintained equipment.

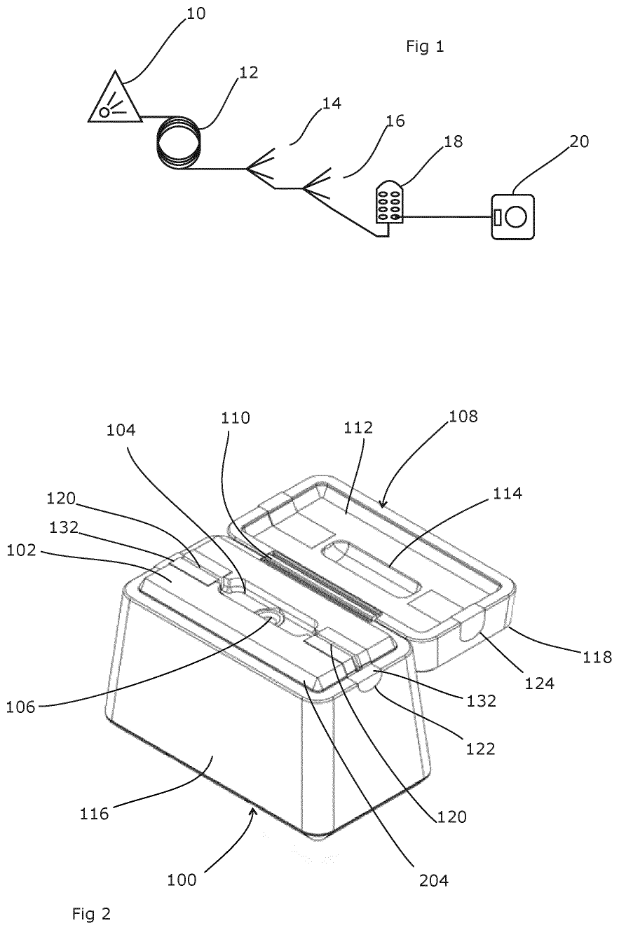

FIG. 1 shows signal strength and dB Loss in the context of a schematic optical network. A source 10 emits a signal at a power level of +5 dBm. It is then sent through a length of optical fibre 12, in this case 4 km long resulting in a −1 dB loss; thus the optical power after the fibre transmission is +4 dBm. It is then split into multiple signal paths to multiple customers, first via a 1:16 splitter 14 that imposes a −12 dB loss reducing the optical power to −8 dBm, and then a 1:4 splitter 16 that imposes a +6dB loss reducing the optical power to −14 dBm. This signal is delivered to a CBT node 18, i.e. a connectorized block terminal marking the end of the permanently-installed network, at which a cable can be connected and laid to the customer service point 20, located at the customer premises. Typically, a loss of −1 dB can be expected in each of these, yielding the typical value of a 16 dBm signal strength at the customer.

In practice, customer signal strength varies across the network. Network architecture and design explains this discrepancy; for example, a single 1:8 splitter alone introduces a loss of roughly −10 dB, and a 1:32 splitter will introduce around −16 dB of loss. Other factors which influence loss are the length of fibre in the network (−0.2 to −0.35 dB/km), the number of connectors (−0.05 to −0.2 dB each) and the number of splices, which vary from <−0.05 dB to >−1.5dB dependent on splice quality.

While splice losses appear low in context here, it is important to note that poor splices have other issues not seen in other elements of the network. One such issue is that the signal loss resulting from a splice can vary with time. In one example from our own testing, a splice with a mean loss of 1 dB showed an oscillation in that loss of around ±0.5dB every few seconds. This variable behaviour will lead to unpredictable behaviour of the customer connection, which is potentially a larger problem from a network health perspective.

Splice losses thus represent an unknown quantity in network strength calculations, since they cannot generally be predicted in advance when designing the network and may vary over time. The ability to measure and record splice quality at the time of creation, and to reject and replace poor splices has the potential to improve the reliability and predictability of the network, and reduce operator costs in dealing with customer complaints. The aim of the device described herein is to develop a product to allow a technician to undertake a swift test (i.e. less that about 1 minute) at the time of installation which will indicates whether the splice is of an acceptable standard. Providing an instrument to assist the technician in field conditions also improves installation compliance, as it identifies a root cause of poor splices and can educate a technician via early feedback.

The causes of poor quality splices are well understood, and many online resources explain them in detail. The most common fault causes are poor quality of cleaving, fibre hygiene, cladding preparation, equipment, or fibre handling. Poor cleaving results in a non-optimal fibre end face; fibre cleavers are very precise instruments and must be well maintained. Poor fibre hygiene such as dirt, dust or grease from hands may affect splicing, as will any remaining pieces of cladding which have not been correctly stripped. Insufficiently careful removal of cladding and/or over removal of cladding also contribute to this. Unsatisfactory or poorly-maintained equipment may also be a factor-affecting splice machine accuracy & data provision, leading to false reading. Rough handling of the fibre, such as when removing it from the splice machine, removing before the splice is fully cooled, etc will also have a detrimental effect.

The splice machine provides an estimate of splice loss also. This involves a visual inspection of the splice, using two internal cameras, immediately after being made. This estimate cannot be always accurate as there is no direct measurement of emitted light, and causes of loss, such as irregularities in the joints between fibre ends may not be visible. These problems are, in our experience, due to operator error in making the splice. This may lead to poor quality splices not being detected, requiring a more exact test method.

Imperfect splices may result in shorter lifetimes and may be more vulnerable to effects such as temperature cycling, vibration, and shock. Due to the factors described above, several percent of all splices in Fibre to the Home (FTTH) applications require a revisit for replacement. This represents significant cost to the network provider. The invention aims to provide a solution that reduces the number revisits and therefore provides a cost saving to network operators.

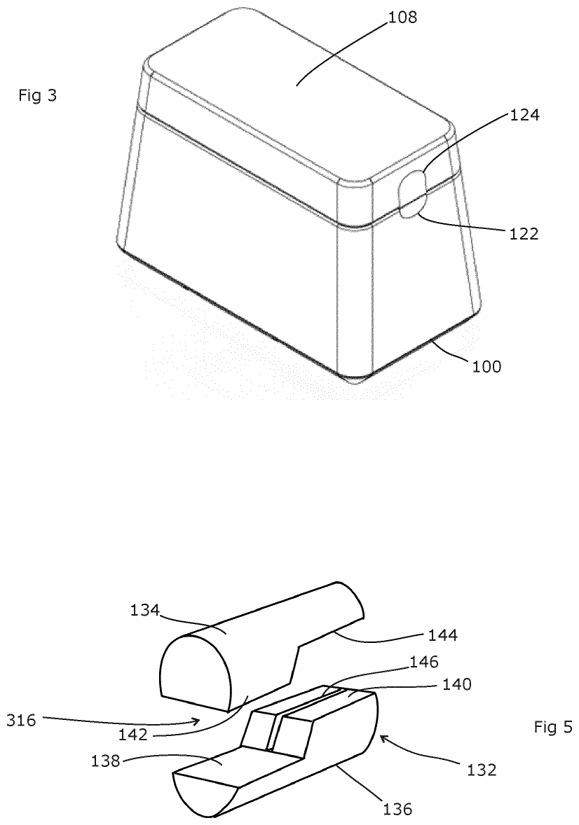

An embodiment of the device is shown in FIGS. 2 to 4. The device is optimised for detection of light at 1490 nm, and will work well in networks using 1250 nm to 1625 nm. It can accommodate both 45 mm and 60 mm splice protectors, and thus works with any fibre size and grade.

The device is composed of two elements, a base portion 100 includes the electronics, signal processing and wireless connectivity elements along with an upper face 102 of a suitably resilient material either side of a channel 104 in which the fibre (not shown) can be placed. The channel 104 has specularly reflective surfaces aside from an opening around a photodiode 106, and the response of the photodiode 106 is detected as part of the testing process. This can be covered with a lid 108 that is attached to the base portion 100 via a hinge 110 allowing the lid 108 to be opened to reveal the channel 104 and closed to shield the channel 104 and a fibre within it from external light sources.

The internal face 112 of the lid 108 has a recess 114, shaped correspondingly to the channel 104 so that when the lid 108 is closed over the base 100, the recess cooperates with the channel 104 to define a hollow interior volume in which the spliced cable lies. The interior faces of the recess 114, like the channel 104, have specularly reflective surfaces so that the walls of the interior volume are entirely reflective apart from the opening to the photodiode 106. The interior volume this forms a cavity into which the splice joint of the optical fibre can be placed. Emission leaking from a poor splice typically have a preferred, but random direction. Reflective surfaces around the interior volume thus ensure a maximum amount of emitted light is captured in the photosensitive element. This allows the detection of IR light intensity to estimate the light lost from the splice, by directing any light leaking from the splice via the reflective surfaces of the interior volume to the photodiode 106.

The specularly reflective surfaces may be formed in a number of ways. The reflective surface can be inherent to the material used to define the cavity, such as stainless steel, chrome, or other metals such as aluminium or gold. This may be emphasised by polishing or other finishing of the material surface. Alternatively, or in addition, the internal surface of the cavity may be coated with a specularly reflective coating such as a metallic or other reflective material, by painting, spraying, or deposition process such as sputtering or evaporative deposition.

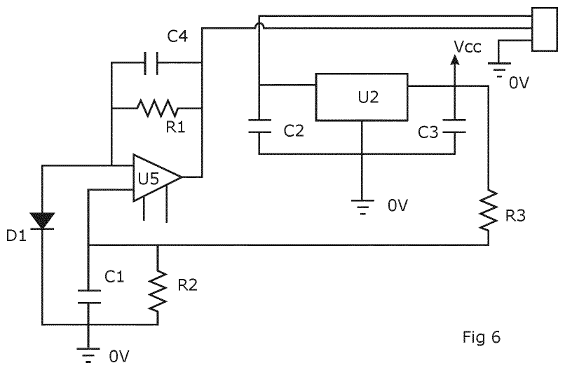

The photodiode is biased by circuitry within the base portion with an applied voltage so that a current flows which is dictated by the incident light level, and which thus reflects the amount of light leaking from the splice. This can be detected with the circuit shown in FIG. 6 or by any suitable circuit.

The base portion 100 comprises a hard moulded shell 116 defining a generally cuboid shape with a base approximately 85 mm by 45 mm, tapering upwardly to the upper face 102 which comprises a generally upstanding convex plateau within which the channel 104 is defined. The plateau is formed of a suitable resilient material, such as silicone. Other materials are possible, or a different mechanical retention means may be provided in order to hold the fibre in a suitable location without causing damage. The lid 108 has a corresponding hard concave shell 118 which closes neatly over the base shell 116, the hinge 110 being located along one of the long edges. Taking into account the taper of the base portion 100, the lid 108 is approximately 35 mm along its short edge. When closed, the interior of the concave shell 118 contacts the resilient silicone of the base upper face 102 and creates an effective seal around the interior volume.

A pair of grooves 120 within the silicone of the upper face 102 extend along most of the distance between notches 122 and 124 in short edges of the moulded shell 116 and the lid 108, allowing the fibre to be accommodated.

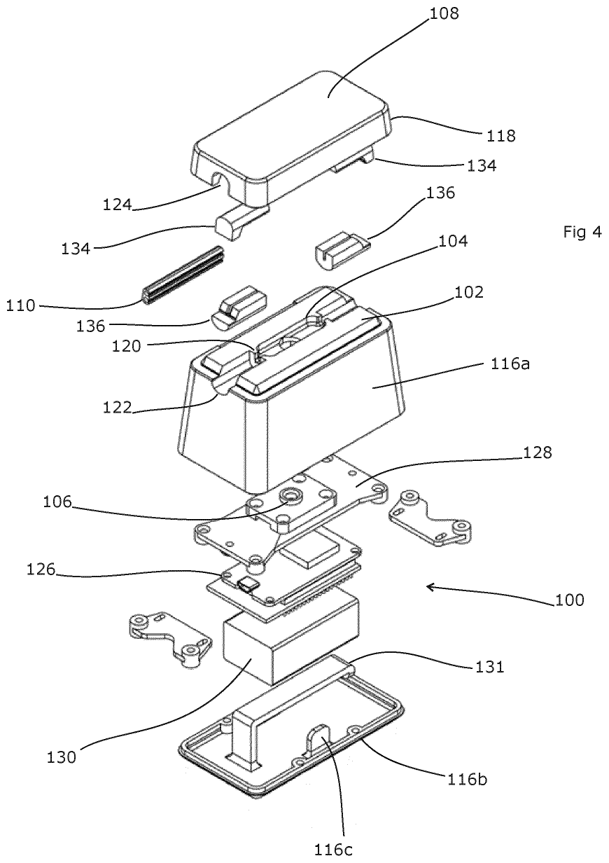

FIG. 4 shows an exploded view of the device internals, including main PCB 126, photodiode housing 128, battery 130. The hinge assembly 110 connects body 116a and lid 108. The main PCB 126 carries the necessary circuitry to perform the functions set out above, along with a short-range rf communications capability such as Bluetooth®. It is powered by the battery 130. The battery 130, PCB 126 and photodiode housing 128 are held in place by a spring element 131, which in this example is formed integrally with the base cover 116b. This fits to the lower open face of the body 116a via resilient clips 116c to form the moulded shell 116 and enclose the battery 130, PCB 126 and photodiode housing 128 within the hollow interior space of the moulded shell 116.

Routing elements 132 hold the optical fibre either side of the splice, and are shown in more detail in FIG. 5. These extend back into the device from the notches 122 and 124 and consist of a malleable, opaque material which, when the lid is closed, applies pressure to ensure correct positioning of the splice while not allowing any ambient light to enter the device. These comprise an upper seal element 134 and a lower seal element 136. Each has an upper or lower face (respectively) shaped to fit into a correspondingly-shaped recess in the lid 108 or base 100 (respectively). In this case, the shape is a half-cylinder but other shapes such as square, cuboid, half-hexagonal and the like may be adopted. Their lower and upper faces (respectively) correspond so that the two parts fit and mate together when the lid 108 is closed onto the base 100. To seal against the fibre and hold it in the correct location, these mating faces are cranked, that of the lower seal element 136 being lower in the region 138 adjacent the outer face of the base 100 and rising to provide an elevated part 140 immediately adjacent the optical cavity. Likewise, the upper seal element 134 has an elevated or thicker region 142 over the lower region 138, which subsides to a thinner region 144 over the elevated part 140.

The elevated part 140 has a longitudinal division 146 extending axially along the seal element and allowing a fibre to be received. The base of the division, i.e. its deepest part, is level with the lower region 138. Thus, a fibre resting on the lower region 138, sandwiched there by the thicker region 142, can extend into the division 146 without bending or kinking. Thus, the two parts 136, 134 can close over a fibre that is initially sandwiched between the lower region 138 and the thicker region 142 and is then held in the division 146. In practice, an operator can insert the fibre by pressing it into the two elevated parts 140 either side of the optical cavity, with the splice in the cavity between them, and then close the lid to seal the cavity and hold the splice in a defined position.

The two routing elements may contain magnetic elements. These are ideally matched to magnets embedded on the inside surface of the lid 108 and/or base 100 to retain the routing elements and ensure a tight seal.

In the illustrated embodiment, the lid 108 is adapted to be hingedly attached to the base portion 100, allowing the lid 208 to be closed over the fibre to hold it in place. In other arrangements, the two body parts could have a snap-fit arrangement to hold the fibre securely in place during measurement. In a further arrangement, the two body parts could simply be held together for the time required to test the splice. An open/closed detector could be included, in the form of (for example) a magnetic reed switch, physical metallic contacts, or a similar element which will detect the opening and closing of the lid element of the device. This can be used to trigger a test, and may replace or supplement other means of powering on and connecting the device.

In addition, a mechanical cover (not shown) can be provided over the sensor array 106 to protects the diode(s) when the device is open. This cover can be arranged to retract automatically when the device is closed and ready for measurement.

Once a measurement has been taken, the device can be re-opened to allow the fibre to be removed and either re-spliced (if unsatisfactory) or secured in position in the interconnection terminal.

The device described above is suitable for testing in-line splice connections between lengths of optical fibre. By suitable adjustment of the size and shape of the internal cavity to fit a field-installable connector, it can be used to check the connection quality between a fibre and a field-installable connector. In the case of a device for testing connectors only, the exit aperture for the fibre can be omitted as only the entry aperture is strictly needed if the connector is enclosed entirely within the cavity.

This can operate using essentially the same methodology and circuitry, etc. Alternatively, a more informative result can be derived by a process of:
1. Inserting the bare (unterminated) fibre and running a first measurement, which will report a reference signal strength. This will (additionally) report the signal strength as observed at the customer location.
2. Prepare the field-installable connector and fit it to the optical fibre.
3. Place the field-installable connector into the test unit and test the signal strength again. This test result should be close to or nearly identical to the reference signal strength. If not, there is a fault of some sort in the connector.
4. Place a cap (such as a dust cap) over the end of the connector, re-insert it into the test unit, and test the signal strength again. This will then detect any light leakage from the body of the field-installable connector.

Optionally, step 3 could be omitted to save time, thus providing a reference signal strength and a leakage measurement only.

Other modifications could be made to the physical shape and configuration of the test unit in order to accommodate other fibres and connection systems, such as ribbon splice protectors which are substantially larger than single fibre splices.

The body 100 also includes ADC conversion elements to create a digital signal based on the observed current flow, and wireless communications ability so as to connect to a nearby a mobile device carried by the operator. In this example, the wireless connectivity is based on the Bluetooth® standard and the mobile device is a smartphone handset carrying a suitable App. The data sent by the device to the handset is captured and displayed on the handset screen, giving instant feedback to the operator as to whether the connection is acceptable or not. The Data can also be uploaded to a cloud storage (or the like) by the app operating via the smartphone's data network, allowing data analysis techniques to be used to continuously improve work practices, establishing root causes of poor splicing (etc) to implement corrective actions as part of continuous training and improvement in installation work practices.

This App ideally displays a very simple interface, such as showing a wholly or mainly green screen indicating a good connection, and a wholly or mainly red screen in the case of a poor connection.

Measurement data is stored to cloud storage via the App, allowing for traceability of faults and, where the device is used on call-outs to repair faults, to trace loss levels which cause faults over time.

NFC and/or RFID tags can be incorporated into the interconnection terminal and queried by the app (or by the electronics within the body part 102, and the data passed to the app). This enables jobs to be logged and an accurate record of all installs to be recorded. If the operator is recalled to an interconnection terminal then it enables the initial connection quality to be reviewed.

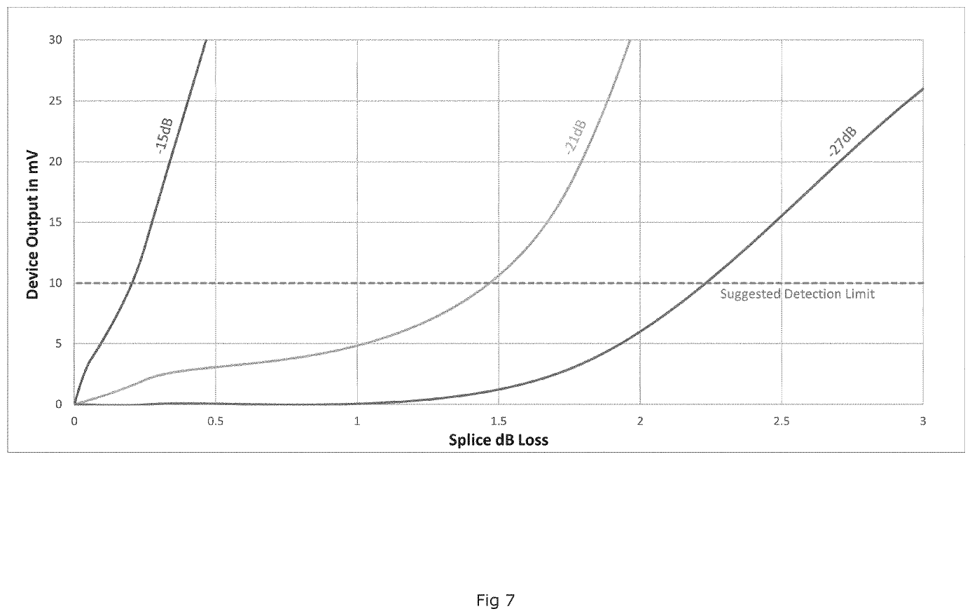

The limits of detection of the devices depend on the incoming signal strength. We have designed the device to accurately detect fully broken splices or failed connections (where no signal reaches customer, causing an Early Life Failure). The design is such that the average customer (at approximately −16 dBm signal strength) will have all connections over 0.3 dB detected as a fault. As the incoming signal strength becomes weaker, the detection threshold increases to, for example, detecting a 1 dB splice loss at −19 dBm incoming signal strength. An estimate of device sensitivity is shown in FIG. 7. This shows the link between device output (in mV) and splice loss (in dB). Each line in the graph represents an incoming signal strength. Maximum device output exceeds 1000 mV, and is not shown, FIG. 7 focusing instead on the critical area of close to 10 mV where our preferred pass/fail detection limit lies. It is likely that the installer will not have an accurate measurement of incoming signal before using the device, and so pass/fail limits are preferably set accordingly.

Sensor array 106 contains the IR sensitive diode and may also include photodiodes, light dependent resistors (LDRs) or similar photosensitive elements which test for the presence of ambient light leaking into the device. This allows for independent validation of “dark” conditions required for accurate measurement. This in turn will (if necessary) trigger a recommendation to users to inspect the device for damage/debris etc that may be affecting the sealing characteristics of the test bed.

The inside of the interior volume is coated in a reflective material, as noted above. This is (ideally) a material that is highly durable, scratch resistant and easily cleaned using the tools available to an installer. These typically consist of alcohol-based cleaning solution, specialist low lint wipes for cleaning glass and ceramic coatings, and low lint cleaning buds. The material is corrosion resistant, non-oxidizing, scratch resistant and resistant to the expected cleaning tools. These surfaces may be easily replaced, with spare parts accompanying the device for field repairs. The material is highly reflective to optical network transmission wavelengths and may be selected from protected aluminium, protected gold, plated steel, protected silver, diamond-like carbon coated plastic, coated ceramic or a similar material which meets the above criteria. Emission from poor connections has a preferred, random direction, and a highly reflective surface ensures the maximum possible amount of light is directed to the photodiode.

With regard to the sensor array 106, in addition to measuring and recording optical measurements, the device may also contain sensors to monitor atmospheric conditions at the time of splicing. These may consist of temperature, humidity and atmospheric pressure sensors, as well as similar methods of recording atmospheric conditions.

Our research suggests that variations in temperature, humidity and atmospheric pressure may play a role in poor connection quality, especially imperfect splicing. The addition of these sensors will add to the utility of the device, as it will allow links between mean splice quality and these factors can be investigated. The interplay of device and software here allows for further research to be carries out both by the device manufacturer and service providers.

The device may also contain an LED or similar light source (not pictured) within the channel 104. This can be used during calibration of the device, to detect imperfections in the reflective coating 205 of the test bed. This measurement can be used to advise the user to clean or replace the reflective surface. This light source could also be used in the measurement phase to detect the presence of a splice in the device; some light would be affected by the presence of a splice or a field-installable connector, such as by varying levels of light transmission through the materials of an optical fibre and elements which protect it, such as a splice protector which often comprise plastics layers and/or a stabilizing metal band or similar. Thus, when a splice or connector is present the detected light output would change in a predictable manner. This could be used to prevent users taking and logging false positive measurements, thus giving greater confidence in the data obtained.

The device may include a means to automatically turn on and connect via Bluetooth or similar wireless communication with a handheld computing device, such as a smart phone, tablet or similar, when the device is opened or closed.

FIG. 5 shows a suitable circuit in schematic form. The diode D1 will make a tiny output current when exposed to light. The op amp U5 output will rise to oppose this current to keep the input terminal voltage difference to zero. This current is controlled by the feedback resistor R1. Capacitor C4 stabilizes the voltage at one amplifying pin of the OpAmp. A similar capacitor-resistor pair C1, R2 stabilize the voltage at second amplifying pin.

The output of a device as described above is shown in FIG. 7 in response to varying degrees of loss within the connection, at three different incoming signal strengths, −15 dBm, −21 dBm and −27 dBm. If a threshold for indicating failure is set at (for example) 10 mV then this will identify 0.25 dB splice losses in a −15 dBm signal, or a 1.5 dB splice loss in a −21 dBm signal, or a 2.25 dB splice loss in a −27 dBm signal. We estimate, based on market research data, that over 90% of customers have incoming signal strengths stronger than −21 dBm. This indicates the device as described is capable of performing well in the vast majority of cases. The −27 dBm curve is included only as a reference of the performance of the device at extremely low incoming signal strengths.

The sensitivity levels of the device could of course be lowered if the network operator preferred to only detect higher loss splices across the network. By routing the data thorough an app, changes such as this can be quickly and easily achieved via the handset's connectivity through app updates.

This device can be used with any fibre type, at any connection point in the network. There is obvious utility in the device both at the install stage and also as a fault finding tool when repairing faults reported in the network.

This device is intended to detect Early Life Failures before they happen, providing savings to the Network operator in repair costs and allow for quick and easy detection of faults for installers, making their work easier, more efficient, and more effective.

Thus, the embodiments described above are:
1) the only available devices which directly measure optical loss in a fibre network without disturbing any element in the network.
2) the only known device to isolate and directly measure light emitted from a fusion splice or field-installable connector.
3) measure optical loss levels across a connection without requiring access to a termination point of an optical network.

This is achieved by using a head which traps light, reflecting and capturing leaking light into a low loss cavity from which accurate optical measurements can be made. This head element ideally excludes substantially all ambient light allowing for accurate and repeatable measurements of splice loss.

Identification of connection faults including partially broken or imperfect splices can be used to estimate the likelihood of future failures. This is a departure from the current state of the art, where installing imperfect connections are not detected and so predicted lifetimes are not attributed to individual splices. Our approach allows for pro-active replacement of a faulty connection before it becomes a problem, saving truck roll costs associated with replacing them at a later date on an urgent call-out basis.

The device also measures and records other factors which contribute to poor connections, such as humidity, temperature and atmospheric pressure. These will provide a record of the conditions localised to the device and connection location. The purpose of this data is that we may be able to predict or provide a greater indication that a splice may fail. These sensors will also ensure that we can validate that our unit is in working order and calibrated correctly-for example, if we detect excess humidity, our unit may be wet.

Relying on a mobile computing device location, we can pair the onboard test device sensors to map test measurements which can provide context to network providers to help predict and prevent faults in real-time.

Although illustrated as a stand-alone device in the above example, the test apparatus described above can be integrated into another device. For example, the test apparatus could be integrated with a splice machine, i.e. one adapted to create a splice between two optical fibre ends. This would allow the splice to be created and tested in a single process step. Parts of the test apparatus such as the first body part and second body part could have a dual purpose, serving to both enclose the newly-created splice during testing and to shield it from the external environment during creation of the splice.

It will of course be understood that many other variations may be made to the above-described embodiment without departing from the scope of the present invention. For example, rather than employing a wireless link to a handset, one or both body parts could include an indicator, such as in the form of a series of LEDs, a screen, or the like, which displays the measured values. The display could be in units of intensity, or in predetermined categories representing the quality of the splice, or in another preferred form. Also, detachable and interchangeable heads can be provided to accommodate a range of different designs of fibres, connectors, splices, and optical splice holders to ensure optical performance of the device.

1. A test apparatus for an optical fibre connection, comprising;
a first body part and a second body part, capable of being brought together around a fibre having a connection, thereby to substantially enclose the connection;
at least the first body part containing specularly reflective surfaces disposed adjacent the connection when the fibre is so enclosed; and
an IR-sensitive photodetector disposed to detect light reflected from the specularly reflective surfaces.

2. The test apparatus according to claim 1 in which the body parts are opaque.

3. The test apparatus according to claim 1 in which a resilient seal is provided on at least one of the body parts, located to form seal with the other body part when brought together.

4. The test apparatus according to claim 1 in which the first and second body parts are hingedly attached.

5. The test apparatus according to claim 1 in which one or more specularly reflective surfaces are also provided on the second body part.

6. The test apparatus according to claim 1 in which the specularly reflective surfaces collectively define an internal space whose surfaces are entirely specularly reflective save for an aperture allowing light to reach the photodetector, an aperture through which the optical fibre enters, and optionally an aperture through which the optical fibre exits.

7. The test apparatus according to claim 1 in which the photodetector is disposed in the second body part.

8. The test apparatus according to claim 1 further comprising an amplifier circuit fed with an output derived from the photodetector.

9. The test apparatus according to claim 1 in which the photodetector is one of a photodiode, photoresistor, phototransistor, or a photovoltaic light sensor.

10. The test apparatus according to claim 1 further comprising sensors adapted to detect at least one of temperature, humidity, atmospheric pressure, moisture levels.

11. The test apparatus according to claim 1 further comprising a light source able to direct light towards at least one of the reflective surfaces and detect the presence of a spliced optical fibre adjacent the reflective surface.

12. The test apparatus according to claim 1 in which the photodetector can detect and differentiate both visible light and infra-red light.

13. The test apparatus according to claim 12 in which the photodetector comprises more than one photosensitive element thereby to detect and differentiate multiple wavelengths of light.

14. The test apparatus according to claim 1, in which the connection is a splice connection between two lengths of optical fibre.

15. A splicing apparatus adapted to create a splice between two optical fibre ends, incorporating a test apparatus according to claim 14.

16. The test apparatus according to claim 1, in which the connection is between an optical fibre and an optical fibre connector.

17. The test apparatus according to claim 16 in which the optical fibre connector is a field-installable connector.

18. The test apparatus according to claim 1 further comprising a wireless transmitter for sending a signal derived from the output of the photodetector.

19. The combination of a test apparatus according to claim 18 and a mobile computing device, wherein the mobile computing device comprises a wireless receiver for receiving a signal transmitted by the wireless transmitter, and a display for showing a test result based on an output derived from the photodetector.

20. The combination of claim 19 in which the mobile computing device is a smartphone handset.

21. The combination of claim 19 in which the mobile computing device includes a network data connection, and carries an application program adapted to transmit the test result to a storage location connected to the network.

22. The combination of claim 19, the test apparatus further comprising sensors adapted to detect at least one of temperature, humidity, atmospheric pressure, moisture levels and in which the test apparatus is further adapted to transmit at least one of the temperature, humidity, atmospheric pressure and/or moisture level data to the mobile computing device for storage along with the test result.

23. A method of testing a field-installable connector, comprising the steps of:
providing a test apparatus according to claim 1;
inserting an unterminated fibre into the test apparatus and measuring a reference signal strength;
terminating the fibre with a field-installable connector;
inserting the terminated fibre into the test apparatus and measuring a signal strength.

24. The method according to claim 23 in which the terminated fibre is inserted once with a cap over the field-installable connector for a measurement of signal strength to be taken, and once without any covering over the field-installable connector, for another measurement of signal strength to be taken.

25. The method according to claim 24 in which the cap is a dust cap.
